(19) United States
(12) Patent Application Publication
(10) Pub. No.: US 2026/0305596 A1
(43) Pub. Date: Oct. 8, 2026

(54) On-Boom Sectional Recirculating Injection System

(71) Applicant: Latitude-Ag, LLC, Humboldt, SD (US)

(72) Inventors: Ladd MCCLUSKEY, Lead, SD (US); Kurt William KAMIN, Plainfield, WI (US)

(73) Assignee: Latitude-Ag, LLC, Humboldt, SD (US)

(21) Appl. No.: 19/641,037

(22) Filed: Apr. 7, 2026

Related U.S. Application Data
(60) Provisional application No. 63/785,193, filed on Apr. 8, 2025.

(51) Int. Cl. A01M 7/00; A01C 23/04; B08B 9/032

(52) U.S. Cl. CPC A01M 7/0092; A01C 23/042; A01C 23/047; A01M 7/0042; B08B 9/0321; B08B 2209/032

(57) ABSTRACT

This recirculating injection system uses an injection recirculation module for each boom section. The injection recirculation module is in fluid communication with recirculation tubing for each boom section, which is curved such that it forms a loop, without dead ends or corners. The injection recirculation module is also in fluid communication with chemical and carrier tanks. Chemicals and carrier are injected into the injection recirculation module, pumped through recirculation tubing, and the liquid returns to the injection recirculation module of that boom section - a closed-loop recirculation section. Cleaning of each boom section is done by stopping the injection of chemicals into the injection recirculation module and allowing only carrier from the carrier tank to flow through the boom section and out the nozzles. The boom sections are rinsed out, but not the chemical tank or chemical lines, reducing the amount of chemicals wasted and released to the environment.

### CROSS-REFERENCE TO RELATED APPLICATIONS

This application claims the benefit of co-pending U.S. Provisional Application No. 63/785,193 filed Apr. 8, 2025.

### FIELD OF INVENTION

This invention relates generally to agricultural or industrial boom sprayers. This invention relates more particularly to a system using injection modules that inject and recirculate chemicals on each section of the boom.

### BACKGROUND

Agricultural and industrial sprayers apply a carrier mixture to desired location or objects. The carrier mixture comprises the effective chemical agent or agents, such as pesticides, fungicides, herbicides, and fertilizers, mixed with a liquid carrier, such as water that may also include surfactants, cleaning agents, wetting agents, or drift retardants. The effective chemical agent or agents are referred to herein as chemicals, whether one or more effective chemical agent is used.

Sprayers range in size from mounted sprayers that are mounted on an ATV, pickup, or tractor, to pull-type sprayers that are pulled by tractors, to self-propelled sprayers. These sprayers have tanks, pumps, and booms components, with a boom up to about 150ft in length. A conventional boom is a single straight horizontal arm made of a series of connected hollow pipes and tubes, equipped with plumbing that includes hoses and hollow tubes with multiple nozzles that spray the carrier mixture across a desired area. The boom may be divided into a plurality of smaller portions to form the whole, where each portion is a boom section. Multiple boom sections may be used on a sprayer to provide the same spray coverage as a conventional single boom. There are typically 2-15 boom sections on a boom sprayer. Conventionally the boom is connected to a tank holding the desired carrier mixture.

Traditional agricultural and industrial sprayers use tank-mixing systems that mix chemicals and carrier as they are pumped into the single large tank, typically 300 to 1800 gallons. The carrier mixture is then pumped under pressure to the boom, thereby filling the entire system with the carrier mixture. The carrier mixture fills the entire system, and the operator can begin spraying the field when ready.

After spraying, any remaining carrier mixture must be flushed from the entire system during cleaning, which includes the tank, hoses, pumps, and boom. Not all the carrier mixture is sprayed out of the nozzles, and the boom sections have endcaps or cleanout valves on the ends for cleanout, requiring manual removal of endcaps or cleanout valves. This design creates significant challenges. This cleaning process takes significant time, exposes operators directly to chemicals, and can lead to environmental discharge of unwanted chemicals. In addition, this system's lack of recirculation limits the ability to address sedimentation or precipitation of the chemicals in each dead-ended boom section.

To address some of these issues, older systems inject chemicals into a mixing chamber located in-line with the sprayer hose-and-boom plumbing directly at or near the carrier tank, and mix it with carrier from the tank. This eliminates the need to clean a mix tank. Even with this improvement, however, many gallons of carrier mixture still remain in the plumbing. For example, the mixing chamber, hoses, and the boom may still have about 60 gallons of carrier mixture remaining in the plumbing, creating waste during cleaning, with accompanying disposal and safety problems.

Other systems mix the chemicals and carrier at the boom section, but because the boom sections have dead ends at the endcap or cleanout valve, sedimentation and chemicals precipitate at the ends. This dead-end structure makes it difficult to clean the boom section after spraying, because it requires manual removal of endcaps or cleanout valves on each boom section to clean the boom section between spray sessions.

It would be desirable to have a sprayer system that reduces chemicals waste, addresses sedimentation and precipitation problems, and improves operator safety. It would be desirable to have a sprayer system in which each boom section recirculates the carrier mixture within the boom section. It would be desirable to have a sprayer system in which each boom section can be cleaned without removing endcaps or cleanout valves on each boom section. It would be desirable to accomplish these goals with a system that can be retrofitted to existing boom sprayers.

### SUMMARY OF THE INVENTION

This recirculating injection system uses an injection recirculation module for each boom section. The injection recirculation module is in fluid communication with recirculation tubing for each boom section. The recirculation tubing is curved such that it forms a loop, without dead ends or corners to prevent trapping sedimentation. In a preferred embodiment, the ends of the recirculation tubing are C-shaped. The injection recirculation module is also in fluid communication with a chemical tank and a carrier tank. The chemicals and carrier are injected into the injection recirculation module at each boom section, pumped through the recirculation tubing, sprayed, and the remaining carrier mixture returns to the injection recirculation module of that boom section, creating a closed-loop recirculation section. The carrier mixture that recirculates within the boom section is not sent back to the chemical or carrier tanks.

Chemicals from a chemical tank and the carrier from a carrier tank are pumped separately to the injection recirculation module, where they are mixed at the desired ratio. The system is computer controlled and ensures precise chemical delivery using programmable valves and flow meters on the chemical lines and optionally the carrier lines.

Cleaning of each boom section is done by stopping the injection of chemicals into the injection recirculation module and allowing only carrier from the carrier tank to flow through the boom section and the nozzles. In this way the boom sections are rinsed out, but not the chemical tank or chemical lines, reducing the amount of chemicals wasted and released to the environment. The amount of rinsate from each boom section when cleaned is less than when cleaning other sprayers.

### BRIEF DESCRIPTION OF THE DRAWINGS

FIG. 1 is a schematic rear view of a sprayer having three boom sections and a recirculating injection system installed on each boom section.

FIG. 2 is a schematic illustration of a rear view of a boom section showing the present invention (not to scale).

FIG. 2A is cross section view of a first embodiment of a sweep end.

FIG. 2B is side view of FIG. 2A.

FIG. 2C is top perspective view of FIG. 2A.

FIG. 2D is a side view of a second embodiment of a sweep end.

FIG. 2E is a side view of a third embodiment of a sweep end.

FIG. 2F is a side view of a fourth embodiment of a sweep end.

FIG. 2G is a side view of a fifth embodiment of a sweep end.

FIG. 3 is a top perspective view of the injection recirculation module.

FIG. 4 is a partially-exploded view of the injection recirculation module of FIG. 3.

FIG. 5 is a side view of the injection recirculation module.

FIG. 6 is cross-sectional view of the injection recirculation module along line A-A of FIG. 5.

FIG. 7 a schematic flow diagram of the injection system using an injector valve and flowmeter.

### DETAILED DESCRIPTION OF THE INVENTION

This recirculating injection system for a boom section uses an injection recirculation module 11 in fluid communication with recirculation tubing 16 for each boom section 50, wherein the recirculation tubing 16 is curved such that it forms a loop, without dead ends or corners. The injection recirculation module 11 and recirculation tubing 16 can be retrofitted on existing boom sprayers. The injection recirculation module 11 is also in fluid communication a carrier tank 40 and a chemical tank 30.

A separate injection recirculation module 11 is connected to each boom section 50. Each injection recirculation module 11 is connected to a carrier tank 40 and separately to one or more chemical tanks 30 holding the chemicals to be sprayed. Because each boom section 50 can be connected to one or more different chemical tanks 30, different chemicals or concentrations can be applied at the same time, enhancing flexibility and customization for complex spraying operations. The system is controlled by a command module A in communication with a controller 18. The controller 18 may use a microcontroller or a microprocessor with memory and other peripherals.

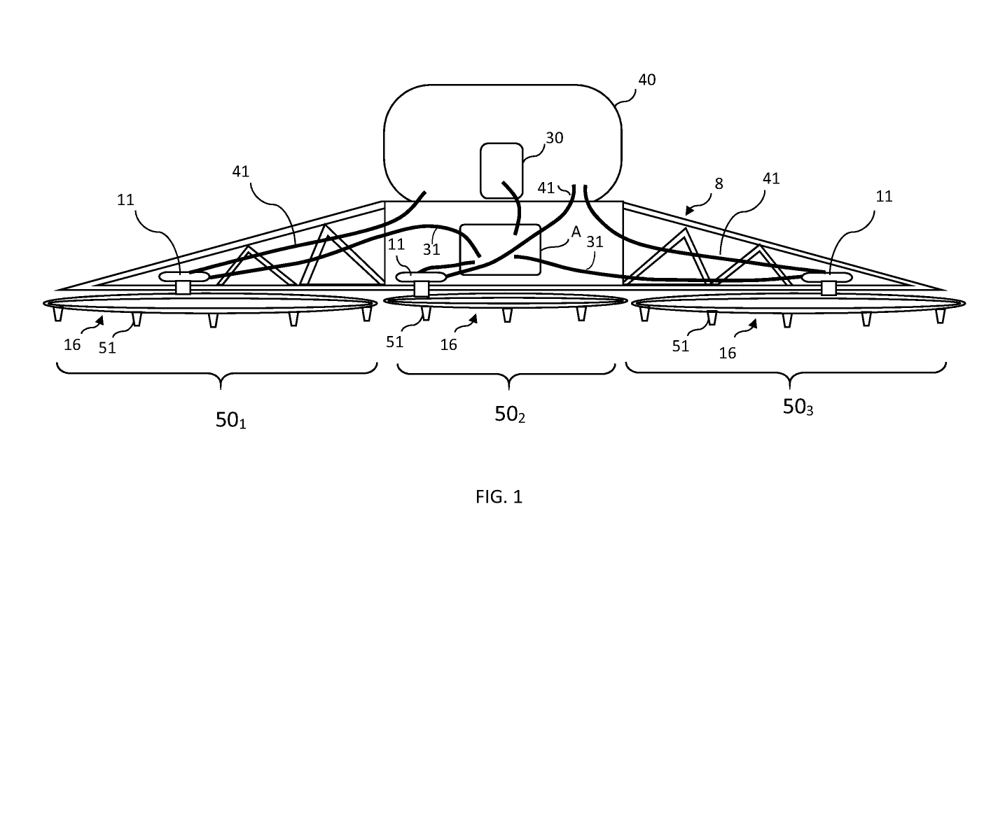

FIG. 1 illustrates a rear view of the recirculating injection system installed on a sprayer 8 having three boom sections 50, labeled as 50₁, 50₂ and 50₃. The number of boom sections 50 used on a sprayer varies depending on a number of factors, including the size of the area to be sprayed, the length of each boom section, and the number of different chemicals to be sprayed on a given pass. Typically a sprayer to spray crop fields will have 2-15 boom sections. One or more spray nozzles 51 are attached to each boom section 50, through which the carrier mixture is sprayed. Typical nozzle spacing for a boom section is 10, 15, 20 or 30 inches. For specific use cases, boom plumbing may be ordered at other than typical spacing. For clarity of the figures, only three boom sections 50 are shown, but a given system may use more or fewer than three boom sections.

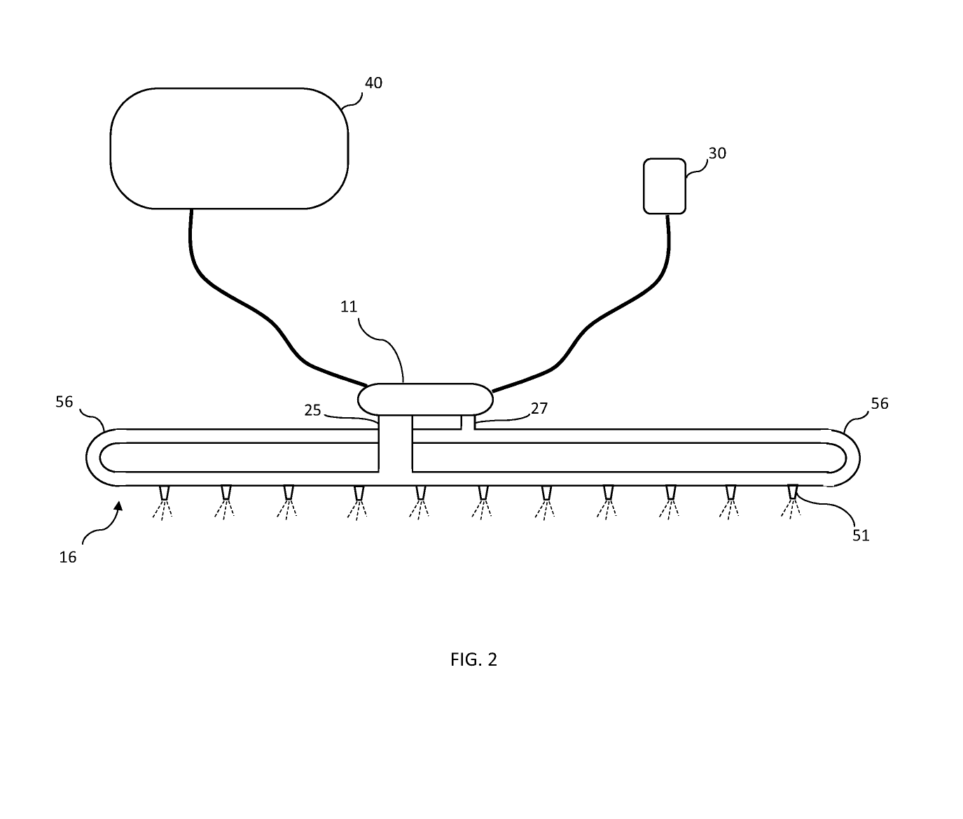

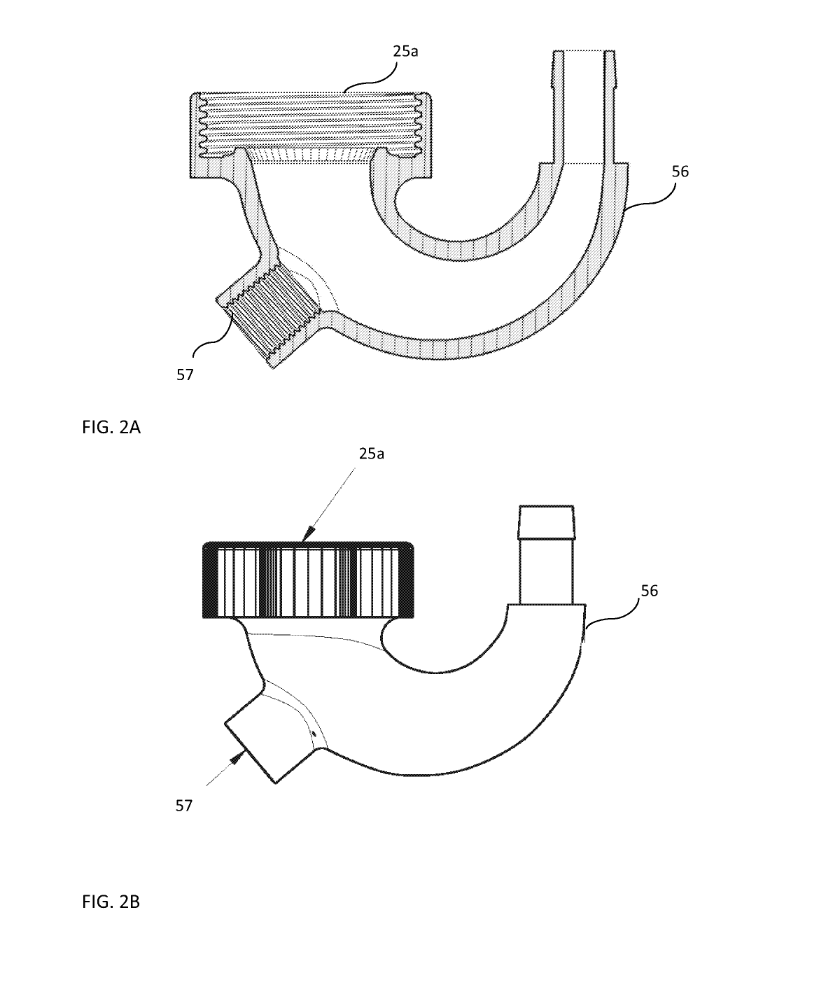

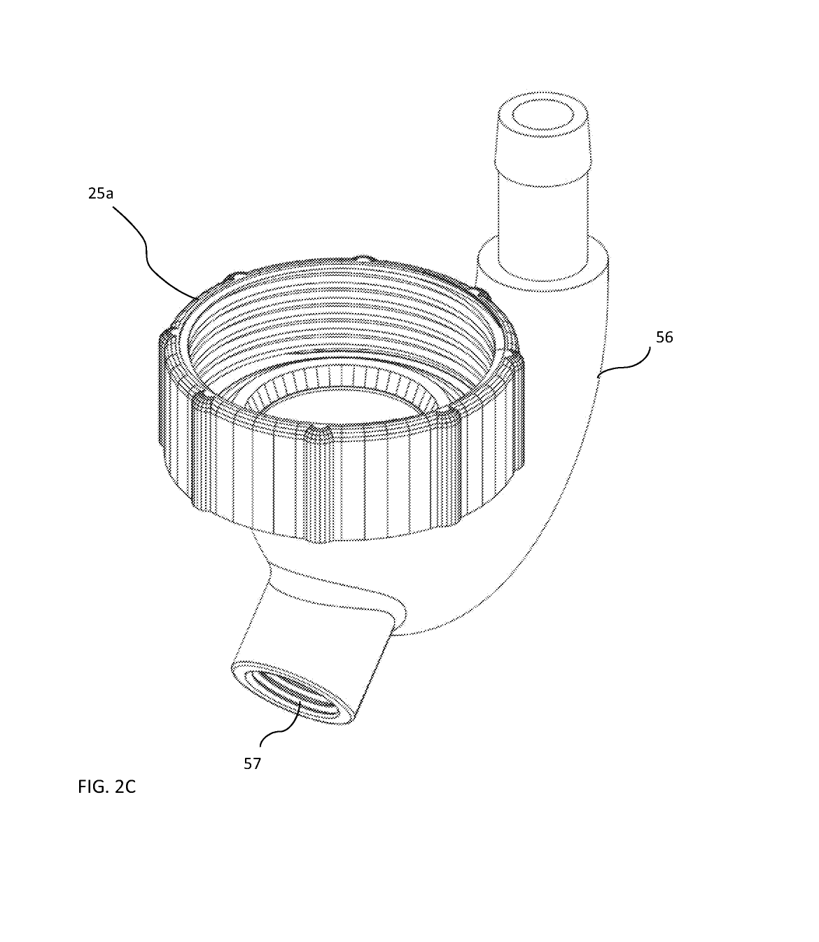

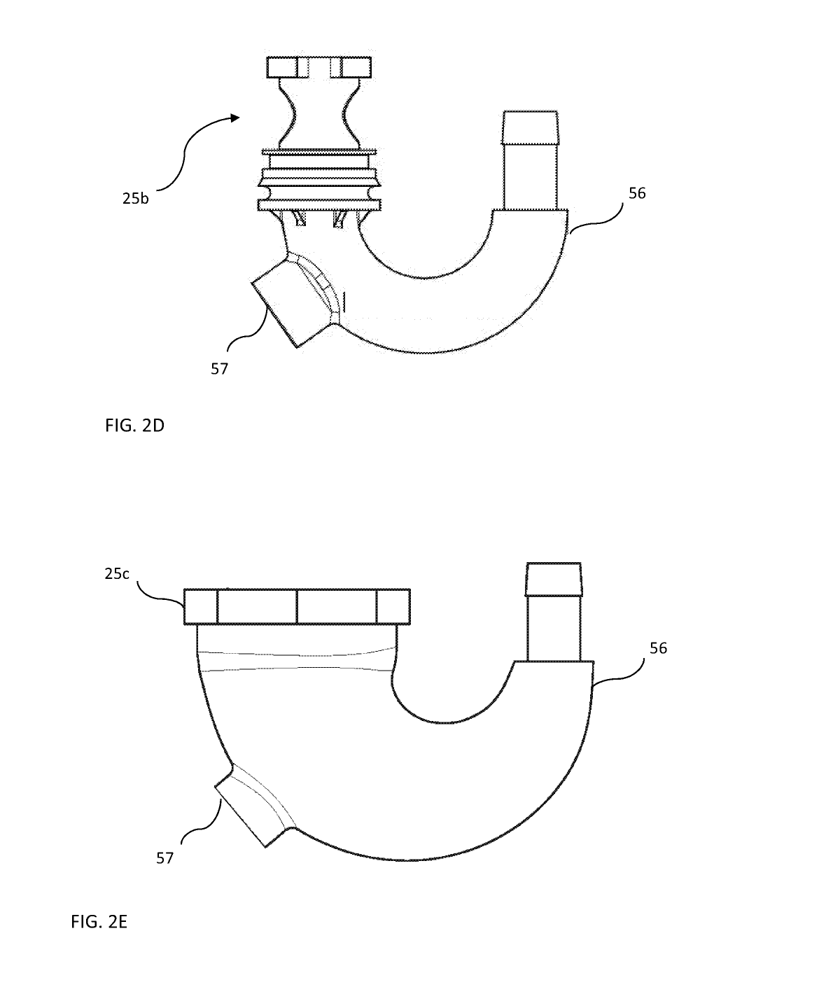

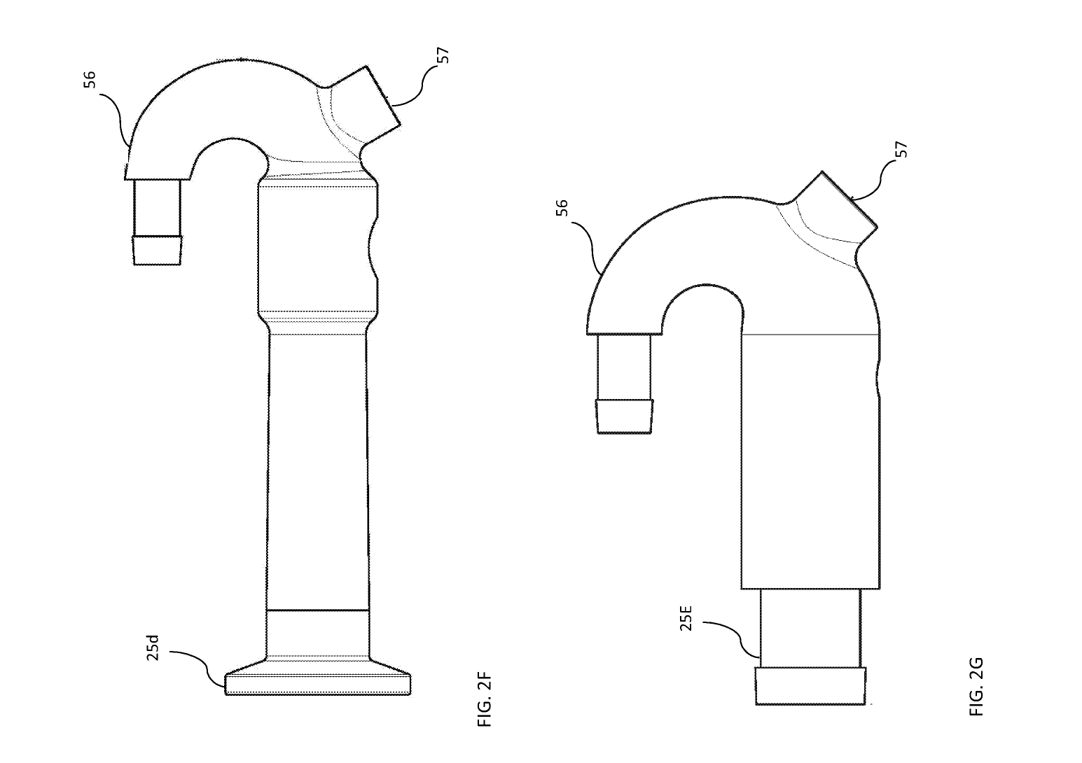

To encourage recirculation of the carrier mixture in the recirculation tubing 16 on each boom section 50, the recirculation tubing 16 is curved in a loop or circle, as opposed to a single straight horizontal arm. Preferably the ends of the loop of recirculation tubing 16, herein referred to as sweep ends 56, are C-shaped, forming 180-degree sweeps. FIG. 2 illustrates the C-shaped 180-degree sweep ends 56 on the recirculation tubing 16. Curves having different shapes and placement may be used provided the loop has no dead ends nor angles where sides meet inside the recirculation tubing 16, such as corners. Tubing without dead ends, corners, or like geometries is referred to herein as recirculation tubing 16 with loop geometry. The inside surface texture of the recirculation tubing 16 may be smooth or not smooth.

In one embodiment of the sweep end 56, the inside diameter of the sweep end 56 is substantially uniform. In another embodiments, the inside diameter of the sweep end 56 may change from one portion to another to modify turbulence, flow rate, mixing location, and to accommodate different types of prior art horizontal boom ends, among other factors.

Many brands of prior art booms are modular, with standardized components and dimensions used in various combination for flexibility in the length and variety of uses. Commonly the tubing on a prior art boom is 1" stainless steel wet boom pipe or 1/2" stainless steel boom pipe. In this invention the pipe may connect to polyethylene or polyethylene-lined rubber blend hose having a diameter of 1” or 1/2" respectively. Each brand of prior art boom has a different way to secure an endcap or other device to the straight horizontal boom arm to close the end of the boom section while spraying.

The recirculation tubing 16 of the present invention can be modular, where each sweep 56 connects to standard diameter tubing pieces. The connections between the sweeps and tubing pieces can be mated threads, hose couplings, friction fit, compression fit, or other fastening methods.

FIGS. 2A-G show several views of several embodiments of sweep ends 56, made to connect to prior art boom tubing and components so that the prior art boom sections can be retrofitted with the sweep ends 56 and additional boom tubing to form a recirculating boom section of the present invention.

FIG. 2A is cross section view of a first embodiment of a sweep end 56. This first embodiment is threaded at 25a to mate with a threaded boom outlet 25. FIG. 2B is side view of FIG. 2A. FIG. 2C is top perspective view of FIG. 2A.

FIG. 2D is a side view of a second embodiment of a sweep end 56. This second embodiment is shaped at 25b to mate with another embodiment of boom outlet 25.

FIG. 2E is a side view of a third embodiment of a sweep end 56. This third embodiment is shaped at 25c to mate with yet another embodiment of boom outlet 25.

FIG. 2F is a side view of a fourth embodiment of a sweep end 56. This fourth embodiment is shaped at 25d to mate with yet another embodiment of boom outlet 25.

FIG. 2G is a side view of a fifth embodiment of a sweep end 56. This fourth embodiment is shaped at 25e to mate with yet another embodiment of boom outlet 25.

FIG. 2 shows chemicals and carrier being fed to the boom section 50 near its middle, but the chemicals and carrier may be fed to the boom section at any point along it, even at an end.

Cleaning each boom section 50 after spraying is accomplished by stopping the injection of chemicals into the injection recirculation module 11 and allowing only carrier from the carrier tank 40 to flow through the boom section 50 and the nozzles 51. This eliminates the need to remove endcaps or cleanout valves on each boom section, as is done in the prior art. Each sweep end 56 may have a port 57 that is closed with a plug (not shown) or can otherwise be closed, which can be opened to winterize the boom section 50 to protect against frozen pipes. Note that the port 57 is not left open when cleaning the chemicals from the sprayer, because the advantage of the on-boom section recirculating system would be lost as the chemicals would spill out.

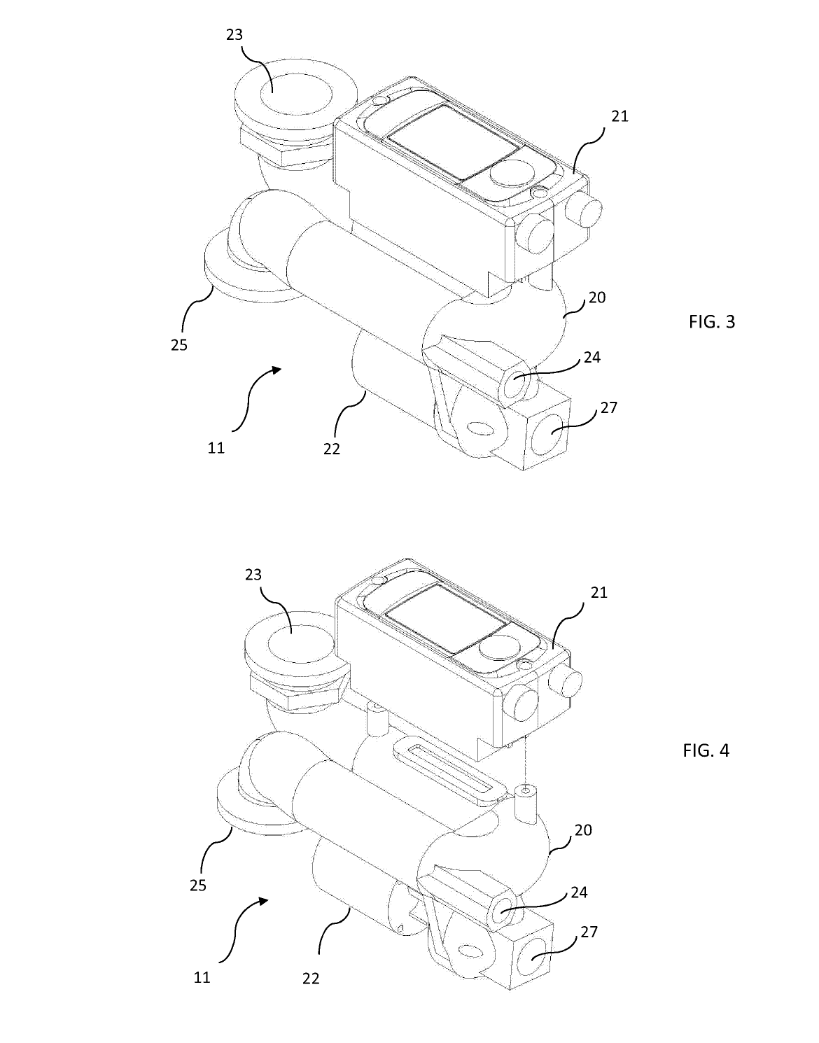

FIG. 3 illustrates an injection recirculation module 11 with a flow meter 21 physically attached to the exterior of the mixing module 20 by magnet or fastener. FIG. 4 shows a partially-exploded view of FIG. 3. The injection recirculation module 11 comprises a carrier inlet 23, a mixing module 20, at least one chemical inlet 24, an outlet 25 to the recirculation tubing 16, a programmable drive pump 22, and a recirculation inlet 27. The injection recirculation module 11 is in fluid communication with the chemical tank 30, the carrier tank 40, and the recirculation tubing 16.

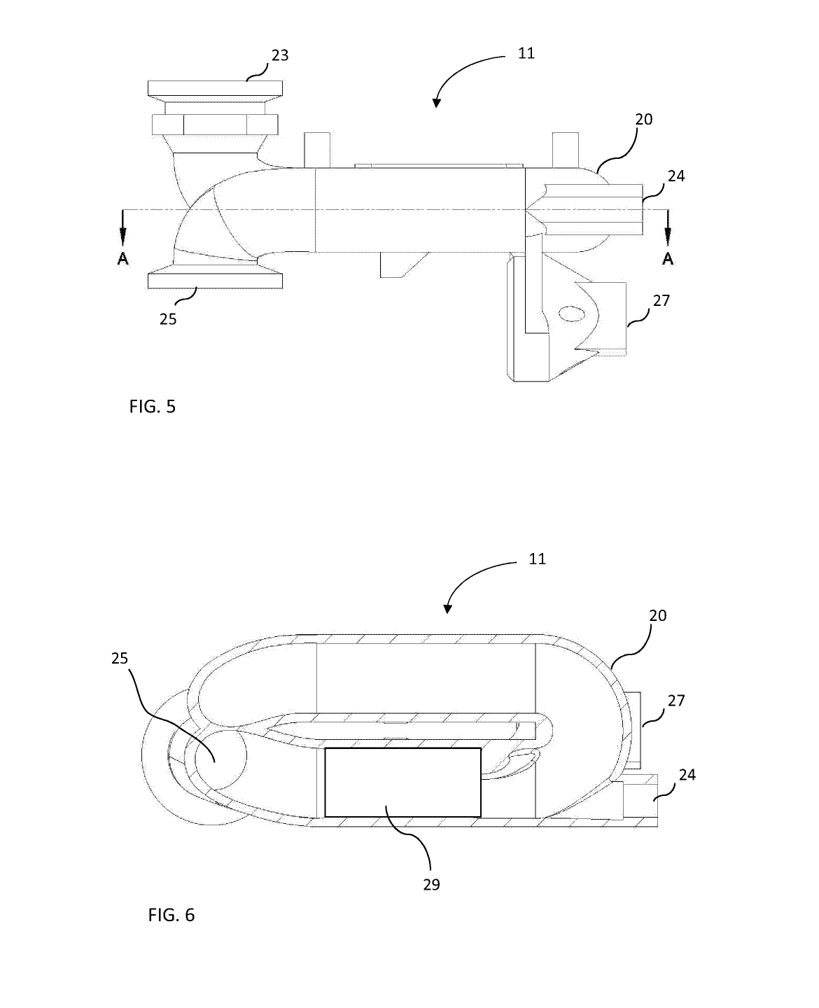

FIG. 5 is a side view of the mixing module 20 without the flow meter 21 or drive pump 22. FIG. 6 shows a cross-section of the mixing module 20 along line A-A. The mixing module 20 has a carrier inlet 23 that is in fluid communication with the carrier tank 40 via carrier line 41. The mixing module 20 also has at least one chemical inlet 24 that is in fluid communication with the chemical tank 30 via a manifold 15 and a chemical line 31. The mixing module 20 may have more than one chemical inlet 24 for injecting different types of chemicals separately from different chemical tanks.

The mixing module 20 is in fluid connection with recirculation tubing 16 at boom outlet 25. Mixing is accomplished in the mixing area 29 using fins, a tortuous chamber, a Venturi effect, or other structure to create turbulence to keep chemicals and carrier thoroughly mixed. The interior of the mixing module 20 has a smooth internal geometry and a void-free inside surface to prevent residue buildup. The boom outlet 25 from the mixing module 20 delivers precisely measured and mixed carrier mixture into recirculation tubing 16 to be sprayed from the nozzles 51. The programmable drive pump 22 on the mixing module 20 recirculates the carrier mixture in recirculation tubing 16 and injection recirculation module 11, ensuring continuous mixing and maintaining chemicals suspension in the carrier, even when nozzles 51 are not spraying. Any carrier mixture that does not exit the recirculation tubing with loop geometry from the spray nozzles 51 is drawn back into the mixing module 20 with the drive pump 22 via recirculation inlet 27, creating a closed-loop recirculation system and ensuring uniform mixing and preventing sedimentation and precipitation from accumulating in the boom section 50.

An optional flow meter 21 detects and measures the flow of the carrier coming into the mixing module 20 at carrier inlet 23 from the carrier tank 40. This enables the system to more precisely determine the amount of chemicals needed for a desired chemical application. The chemicals are injected slightly downstream of the flow meter 21 at chemical inlet 24. The flow meter 21 may be a mechanical sensor, differential pressure flow sensor, electromagnetic sensor or other type of sensor. The flow meter 21 is preferably a non-contact flow meter such as those that use lasers, infrared, sonar or ultrasonic waves to detect the flow without touching the fluid. Preferably the flowmeter 21 is an ultrasonic transducer. In one embodiment, the flow meter 21 is attached externally to the mixing module 20 immediately downstream from the carrier inlet 23. The flowmeter 21 sends signals to the controller 18 which changes the flow rate of chemicals as needed to achieve desired concentration sprayed.

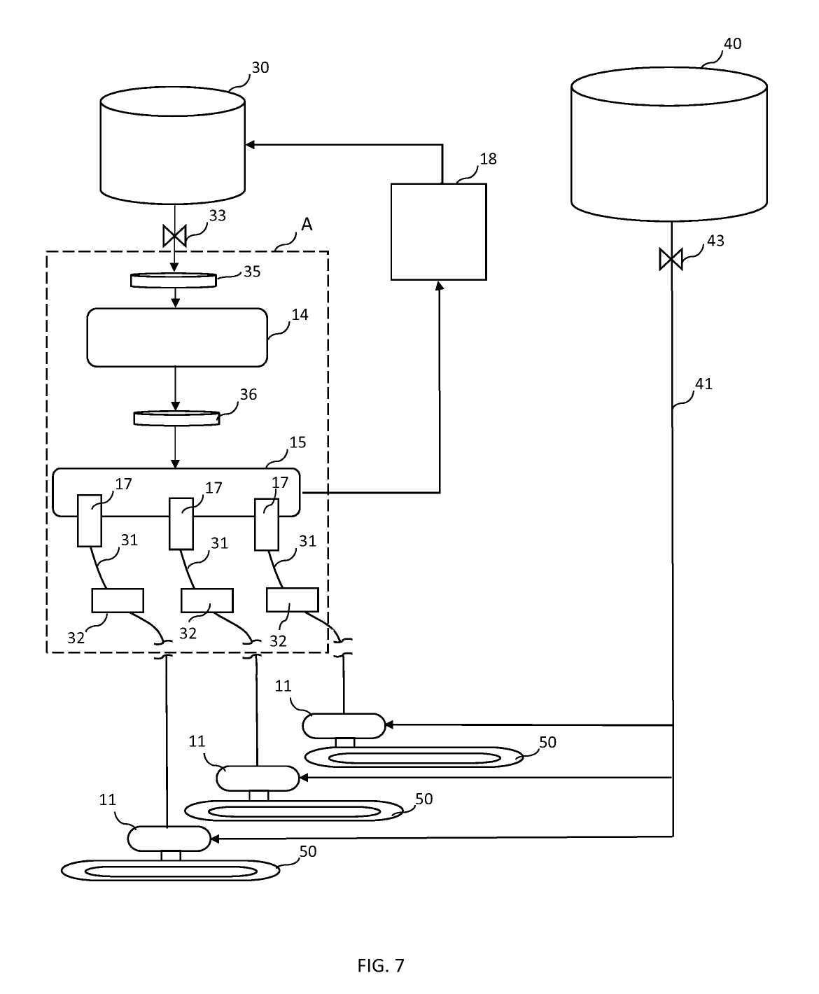

FIG. 7 is a flow diagram of an embodiment of the present invention, where the dotted line denotes the command module A. A chemical tank 30 is in fluid communication with an electric chemical pump 14 and a manifold 15 to distribute chemicals to each injection recirculation module 11 on each boom section 50. In one embodiment a programmable injection valve 17 is connected to the manifold 15 for each boom section 50. FIG. 7 shows three injector valves 17, one each for the three boom sections 50. The chemicals released from the injection valve 17 travel along a tube or hose, referred to herein as a chemical line 31, to the mixing module 20 in the injection recirculation module 11. The flow rate of the chemicals is sensed and measured using a flow meter 32 on each chemical line 31 after the injection valve 17. This is in contrast to prior art injection systems which use a fixed volume pump without a flow meter after the injection point, so once the injection is calibrated, they can’t read the amount of chemical that is being injected into the system. The present invention enables the system to continuously verify the amount of chemicals output by injection valve 17 as a self-check, and change the output of injection valve 17 accordingly to achieve the desired amount of chemical injected into the injection port 24. This also enables the system to accommodate for temperature change from a cold morning to a warm afternoon, without recalibration of the injection valve.

Many types of flow meters can be used and, again, preferably the flow meter 21 is a noncontact ultrasonic flow meter 32. A shutoff valve 33 is connected between the chemical tank 30 and the chemical pump 14. One or more filters 35, 36 may also be connected between the chemical tank 30 and the chemical pump 14 to help filter sediment and prevent nozzle blockages.

A carrier tank 40 is in fluid communication with each injection recirculation module 11 on each boom section 50. The carrier released from the carrier tank 40 travels along a tube or hose, referred to herein as a carrier line 41. A shutoff valve 43 is connected between the carrier tank 40 and the injection recirculation modules 11. One or more filters (not shown) may also be connected between the carrier tank 40 and the injection recirculation modules 11 to help filter sediment. The flow rate of the carrier is generally governed by the brand or model of the sprayer and is consistent. The flow rate of the carrier may be sensed, measured, and controlled using a flow meter between the carrier tank and each mixing module 20. Again, preferably the flow meter is a noncontact ultrasonic flow meter.

The system is computer controlled and ensures precise chemical delivery using the programmable valves and flow meters on both the chemical lines and, optionally, the carrier lines, to areas ranging in size from essentially spot treatment to large swathes across crop fields. Conventional ISOBUS communication protocols used in agricultural and forestry machinery may be used. The controller 18 may coordinate with GPS sensors and timestamps to show, record, and report precisely where the carrier mixture is sprayed, the number of acres sprayed, the type and amount of chemicals sprayed, date, time, air temperature, and the concentration and duration of the spray. This combination prevents excess chemicals from being sprayed where they are not needed, reducing cost and environmental impact.

Preferably the controller 18 and other controls for the system are remote from the boom section. In particular, preferably the controller 18 for operating the flow from the chemical tank and the carrier tank is in the cab of the sprayer for ease of use by the operator. This way the operator may clean out the boom sections without leaving the cab, limiting exposure to the chemicals.

In operation, the operator specifies the carrier flow rate and desired chemical flow rates per acre in the system's control panel. The system calculates the necessary chemicals-to-carrier ratio. The flow to each mixing module 20 is monitored using flow meters for each boom section 50. Chemicals are injected directly into each mixing module 20 via the programmable injection valve 17 and chemical line 31. The precisely-mixed carrier mixture is sprayed out of the nozzles 51 on each boom section 50 and the drive pump 22 draws remaining carrier mixture back into the injection recirculation module 11, ensuring uniform mixing and preventing sedimentation. The drive pump 22 may be a sealed or sealless pump, but is preferably a sealless pump such as magnetic drive pump or canned motor pump.

When cleaning the sprayer, the boom sections are rinsed out, but the chemical tank and carrier tank do not have to be rinsed out. Cleaning the sprayer is a one-button process from the cab, stopping the chemicals injection and allowing the sprayer to spray the carrier out the nozzles only so that the boom section is emptied of chemicals. The amount of rinsate from each boom section when cleaned is minimal, at about 1 gallon for every 15 ft of boom. The process is quick and efficient, taking under 5 minutes. There’s no operator exposure to effective chemicals and cleanout is quick, resulting in improved productivity, environmental safety and operator health.

While there has been illustrated and described what is at present considered to be the preferred embodiments of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims and equivalents thereof.

1. A recirculating injection system for a boom section, the system comprising:
an injection recirculation module in fluid communication with:
recirculation tubing for the boom section;
a chemical tank; and
a carrier tank.

2. The recirculating injection system for a boom section of claim 1 wherein the recirculation tubing on the boom section has loop geometry.

3. The recirculating injection system for a boom section of claim 2 wherein the recirculation tubing on the boom section has one or more sweep ends.

4. The recirculating injection system for a boom section of claim 3 wherein at least one of the one or more sweep ends is C-shaped.

5. The recirculating injection system for a boom section of claim 1 further comprising a controller to operate the flow from the chemical tank to the injection recirculation module, wherein the controller is located remote from the boom section.

6. The recirculating injection system for a boom section of claim 5 wherein the controller is in communication with one or more GPS sensors.

7. A recirculating injection system for a boom sprayer, the system comprising:
an injection recirculation module in fluid communication with:
recirculation tubing for at least one boom section, wherein the recirculation tubing on the boom section has loop geometry;
a chemical tank;
a carrier tank; and
a controller to operate the flow from the chemical tank to the injection recirculation module, wherein the controller is located remote from the boom section.

8. The recirculating injection system for a boom sprayer of claim 7 wherein the controller is located in the cab of the sprayer.

9. The recirculating injection system for a boom sprayer of claim 7 further comprising:
an injection valve in fluid communication between the chemical tank and the injection recirculation module for each of the at least one boom sections; and
a flow meter in fluid communication between the injection valve and the injection recirculation module for each of the at least one boom sections;
wherein the controller can modify the amount of chemical injected from the injection valve into the injection recirculation module for each of the at least one boom sections.

10. The recirculating injection system for a boom sprayer of claim 7 wherein the controller is in communication with one or more GPS sensors.

11. The recirculating injection system for a boom sprayer of claim 7 wherein the recirculation tubing on the boom section has one or more sweep ends.

12. The recirculating injection system for a boom sprayer of claim 7 wherein at least one of the one or more sweep ends is C-shaped.

13. A method for cleaning a boom section comprising:
using a controller to stop the flow from a chemical tank to a recirculating injection system in fluid communication with the boom section; and
using a controller to allow the flow from a carrier tank through one or more nozzles of the recirculating injection system;
wherein the recirculating injection system comprises a recirculating injection module in fluid communication with:
recirculation tubing having loop geometry;
the chemical tank; and
the carrier tank.

14. The method of claim 13 wherein the controller is in communication with one or more GPS sensors.

15. The method of claim 13 wherein the controller is located remote from the boom section.

16. The method of claim 13 wherein the controller is located in a cab of a sprayer to which the boom section is attached.

17. The method of claim 13 wherein the recirculation tubing on the boom section has one or more sweep ends.

18. The method of claim 13 wherein the wherein at least one of the one or more sweep ends is C-shaped.
